(19) United States
(12) Patent Application Publication
(10) Pub. No.: US 2025/0392000 A1
(43) Pub. Date: Dec. 25, 2025

(54) SOLID ELECTROLYTE MEMBRANE AND ALL-SOLID-STATE RECHARGEABLE BATTERIES

(71) Applicant: SAMSUNG SDI CO., LTD., Yongin-si, Gyeonggi-do (KR)

(72) Inventors: Gunwook LEE, Yongin-si, Gyeonggi-do (KR); Sieun LEE, Yongin-si, Gyeonggi-do (KR); Eungyeong LEE, Yongin-si, Gyeonggi-do (KR); Jaemin KIM, Yongin-si, Gyeonggi-do (KR); Jaejun LEE, Yongin-si, Gyeonggi-do (KR)

(73) Assignee: SAMSUNG SDI CO., LTD., Yongin-si, Gyeonggi-do (KR)

(21) Appl. No.: 18/880,454

(22) PCT Filed: Mar. 27, 2024
(86) PCT No.: PCT/KR2024/003838

§ 371 Date: Dec. 31, 2024

(30) Foreign Application Priority Data
Jun. 22, 2023 (KR) 10-2023-0080597

(51) Int. Cl. H01M 50/42; H01M 10/052; H01M 10/0562; H01M 50/403; H01M 50/423

(52) U.S. Cl. CPC H01M 50/42; H01M 10/052; H01M 10/0562; H01M 50/403; H01M 50/423; H01M 2300/0068

(57) ABSTRACT

Disclosed are a solid electrolyte membrane, and an all-solid-state rechargeable battery, the solid electrolyte membrane including a sulfide-based solid electrolyte, a binder, a first solvent, and a second solvent, wherein the first solvent is at least one selected from butyl butyrate, isobutyl isobutyrate, tetrahydrofuran, and ethyl acetate and the second solvent is at least one selected from hexyl butyrate, benzyl butyrate, benzyl isobutyrate, isopentyl butyrate, and octyl acetate.

### TECHNICAL FIELD

Solid electrolyte membranes and all-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries, and can reduce the thickness of the negative electrode, improving high-rate charging and discharging performance, and realizing high-voltage driving and high energy density.

As a solid electrolyte, a sulfide-based solid electrolyte with high ionic conductivity is mainly used. Among them, an argyrodite-type sulfide-based solid electrolyte can exhibit high ionic conductivity close to a range of 10-4 to 10-2 S/cm, which is the ionic conductivity of a typical liquid electrolyte, at room temperature, and has the advantage of forming a close bond between solid electrolytes and a close bond between the solid electrolyte and the positive electrode active material due to soft mechanical properties. Accordingly, an all-solid-state rechargeable battery using an argyrodite-type sulfide-based solid electrolyte can exhibit improved rate capability, coulombic efficiency, and cycle-life characteristics.

### DISCLOSURE

By resolving the non-uniformity of binder distribution within a solid electrolyte membrane, the durability and high-rate characteristics of the solid electrolyte membrane and an all-solid-state rechargeable battery including the same are improved.

In an embodiment, a solid electrolyte membrane includes a sulfide-based solid electrolyte, a binder, a first solvent, and a second solvent, wherein the first solvent is at least one selected from butyl butyrate, isobutyl isobutyrate, tetrahydrofuran, 2-methylbutyl butyrate, and ethyl acetate, and the second solvent is at least one selected from hexyl butyrate, benzyl butyrate, benzyl isobutyrate, isopentyl butyrate, and octyl acetate.

Some embodiments provide an all-solid-state rechargeable battery including a positive electrode, a negative electrode, and the aforementioned solid electrolyte membrane between the positive electrode and the negative electrode

According to an embodiment, a solid electrolyte membrane has a binder uniformly distributed inside, or a greater amount of binder is distributed on the surface in contact with the positive electrode, thereby improving durability and electrochemical characteristics such as rate characteristics and cycle-life characteristics of an all-solid-state rechargeable battery.

### DESCRIPTION OF THE DRAWINGS

FIGS. 1 and 2 are cross-sectional views schematically showing all-solid-state rechargeable batteries according to an embodiment.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Solid Electrolyte Membrane

In an embodiment, a solid electrolyte membrane includes a sulfide-based solid electrolyte, a binder, a first solvent, and a second solvent, wherein the first solvent is at least one selected from butyl butyrate, isobutyl isobutyrate, tetrahydrofuran, 2-methylbutyl butyrate, and ethyl acetate, and the second solvent is at least one selected from hexyl butyrate, benzyl butyrate, benzyl isobutyrate, isopentyl butyrate, and octyl acetate.

The solid electrolyte membrane according to an embodiment includes two or more solvents. The solvents are used to disperse the solid electrolyte particles and the like during the process of manufacturing the solid electrolyte membrane, and although a portion of the solvents may be evaporated in a drying process and the like during the manufacturing process of the solid electrolyte membrane, a small amount thereof may remain in the final solid electrolyte membrane

The first solvent may have higher volatility, a higher boiling point, a higher vapor pressure, or higher binder solubility than the second solvent, and the second solvent may have lower volatility, a lower boiling point, a lower vapor pressure, or lower binder solubility than the first solvent.

The solid electrolyte membrane, after preparing the composition including the solid electrolyte, the solvent, the binder, and the like, may be formed by coating the composition on a releasing film and then, drying it in the form of a self-supporting membrane or by directly coating the composition on a negative electrode and then, drying it. A solid electrolyte, unlike a liquid electrolyte, has characteristics of being in a solid particle state, vulnerable to moisture, and the like, which may put high limitations on selecting a solvent and a binder, and in addition, there may be problems that the binder may more act as a resistor to movement of lithium ions and furthermore, may not be well dispersed but sink down to the bottom and thus exist only on the lower surface of the final solid electrolyte membrane at a high concentration during the manufacturing process of a solid electrolyte membrane, resultantly reducing adhesion with a positive electrode, lowering durability, and deteriorating high rate capability of a battery.

In an embodiment, both the first and second solvents are all used as the solvent in the manufacture of the solid electrolyte membrane, so that when coated in the form of a membrane, the first solvent may be first volatilized or move toward an upper portion of the membrane to move the binder from the bottom to the top, while the second solvent may not be volatilized but help the binder dispersed within the membrane. In the manufactured solid electrolyte membrane, the binder may not be concentrated at the bottom but evenly or uniformly distributed within the membrane or distributed at a higher concentration on the upper portion of the membrane or the surface thereof in contact with the positive electrode in a thickness direction of the solid electrolyte membrane, for example, exhibit a concentration gradient in which a content of the binder gradually increases from the bottom to the top

Such a solid electrolyte membrane may improve adhesion to the positive electrode as well as the negative electrode, enhance durability, and improve high rate capability, cycle-life characteristics, and the like of the battery.

For example, the first solvent may have a boiling point of less than 190° C., and the second solvent may have a boiling point of greater than or equal to 190° C. Specifically, the first solvent may have a boiling point of 60° C. to 180° C., or 80° C. to 170° C. and the second solvent may have a boiling point of 200° C. to 280° C., or 200° C. to 260° C. Here, the boiling point is a value at atmospheric pressure of 760 mmHg.

For example, the first solvent may have a vapor pressure of greater than or equal to 1.00 mmHg and the second solvent may have a vapor pressure of less than 1.00 mmHg. Specifically, the first solvent may have a vapor pressure of 1.00 mmHg to 20 mmHg, or 1.20 mmHg to 10 mmHg and the second solvent the first solvent may have a vapor pressure of 0.001 mmHg to 0.90 mmHg, or 0.01 mmHg to 0.80 mmHg. Here, the vapor pressure is a value at a temperature of 25° C.

The first solvent may be included in an amount of less than or equal to 0.1 wt %, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt % based on 100 wt % of the solid electrolyte membrane.

The second solvent may be included in an amount of less than or equal to 0.1 wt %, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt % based on 100 wt % of the solid electrolyte membrane.

A weight ratio of the first solvent to the second solvent within the solid electrolyte membrane may be 10:90 to 95:5, for example, 40:60 to 95:5, 50:50 to 95:5, 60:40 to 95:5, or 70:30 to 90:10. When the weight ratio of the first solvent and the second solvent satisfies the above range, the processability can be improved and the dispersibility of the binder can be further improved.

The solid electrolyte membrane may include other solvents in addition to the first solvent and the second solvent as needed, and may further include, for example, a solvent such as xylene, toluene, benzene, and hexane.

### Binder

Any binder that can adhere solid electrolyte particles well without adversely affecting the solid electrolyte can be applied without limitation. For example, the binder may be a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinyl chloride, carboxylated polyvinyl chloride, polyvinyl fluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

For example, the binder may be a rubber-based binder, and specifically may be a nitrile-butadiene rubber, a hydrogenated nitrile-butadiene a rubber, styrene-butadiene rubber, an acrylated styrene-butadiene rubber, an acrylonitrile-butadiene rubber, an acrylic rubber, a butyl rubber, a fluorine rubber, a natural rubber, or a combination thereof.

The binder may be included in an amount of 0.1 wt % to 3 wt %, for example 0.5 wt % to 2 wt %, or 0.5 wt % to 1.5 wt % based on 100 wt % of the solid electrolyte membrane. If the content of the binder is excessive, ion conductivity of the solid electrolyte membrane may be deteriorated, but if the content of the binder is too small, adhesion may be deteriorated, thereby deteriorating durability and battery reliability.

As described above, the binder may be evenly or uniformly distributed in the solid electrolyte membrane, but for another example, the binder may be distributed at a higher concentration on the surface in contact with the positive electrode than the surface in contact with the negative electrode within the solid electrolyte membrane, for example, exhibit a concentration gradient within in solid electrolyte membrane in which the binder may be distributed at an increasing concentration from the surface of the negative electrode toward the surface of the positive electrode. Herein, the adhesion with the positive electrode may not only be improved, but also durability may be reinforced and in addition, high rate capability and the like of the battery may be improved.

### Solid Electrolyte

The solid electrolyte may be an inorganic solid electrolyte, such as a sulfide-based solid electrolyte or an oxide-based solid electrolyte.

In an embodiment, the solid electrolyte may be a sulfide-based solid electrolyte having excellent ionic conductivity. The sulfide-based solid electrolyte may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SIS₂—LiBr, Li₂S—SiS₂—LiCl, Li₂S—SiS₂—B₂S₃—LiI, Li₂S—SIS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte particles according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte particles may include argyrodite-type sulfide. The argyrodite-type sulfide-based solid electrolyte may have high ionic conductivity close to the range of 10-4 to 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

For example, the argyodite-type sulfide-based solid electrolyte particles may include a compound represented by Chemical Formula 11.

(LiₐM¹_{b}M²_{c})(P_{d}M³ₑ)(S_{f}M⁴_{g})Xₕ [Chemical Formula 11]

In Chemical Formula 11, 4≤a≤8, M¹ is Mg, Cu, Ag, or a combination thereof, 0≤b<0.5, M² is Na, K, or a combination thereof, 0≤c<0.5, M³ is Sn, Zn, Si, Sb, Ge, or a combination thereof, 0<d<4, 0≤e<1, M⁴ is O, SOₙ, or a combination thereof, 1.5≤n≤5, 3≤f≤12, 0≤g<2, X is F, Cl, Br, I, or a combination thereof, and 0≤h≤2.

For example, the halide element (X) may be necessarily included in Chemical Formula 11, and in this case, it may be expressed as 0<h≤2. For example, M¹ element may be necessarily included in Chemical Formula 1, and in this case, it may be expressed as 0<b<0.5. In Chemical Formula 11, M³ may be understood as an element substituted for P and may be 0<e<1. In Chemical Formula 11, M⁴ is substituted for S, for example may be 0<g<2, and f, a ratio of S, may be for example 3≤f≤7. If M⁴ is SOₙ, SOₙ may be for example S₄O₆, S₃O₆, S₂O₃, S₂O₄, S₂O₅, S₂O₆, S₂O₇, S₂O₈, SO₄, SO₅, and the like.

For example, in Chemical Formula 11, a+b+c+h=7, d+e=1, and f+g+h=6.

As an example, the argyrodite-type sulfide-based solid electrolyte particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06)}P(S_{4.60}(SO₄)_{0.15})Cl_{1.25}, (Li_{5.72}CU_{0.03})P(S_{4.725}(SO)₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof, but is not limited thereto.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Herein, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

An average particle diameter (D50) of the sulfide-based solid electrolyte particles may be for example 0.1 μm to 5.0 μm or 0.1 μm to 3.0 μm, or the sulfide-based solid electrolyte particles may be small particles of 0.1 μm to 1.9 μm or large particles of 2.0 μm to 5.0 μm. The sulfide-based solid electrolyte particles may be a mixture of small particles with an average particle diameter of 0.1 μm to 1.9 μm and large particles with an average particle diameter of 2.0 μm to 5.0 μm. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

The solid electrolyte may include an oxide-based inorganic solid electrolyte in addition to the sulfide-based material. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0<y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Gamet-based ceramics Li₃₊ₓLa₃M₂O₁₂ (wherein M=Te, Nb, or Zr; and x is an integer of 1 to 10), or a mixture thereof.

The solid electrolyte may further include a halide-based solid electrolyte. The halide-based solid electrolyte includes a halogen element as a main component, meaning that a ratio of the halide element to all elements constituting the solid electrolyte may be greater than or equal to 50 mol %, greater than or equal to 70 mol %, greater than or equal to 90 mol %, or 100 mol %. For example, the halide-based solid electrolyte may not include a sulfur element.

The halide-based solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof and for example it may be Cl, Br, or a combination thereof. For example, the halide-based solid electrolyte may be LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). For example, the halide-based solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof, but is not limited thereto.

The solid electrolyte is in the form of particles and may have an average particle diameter (D50) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte can effectively penetrate between the positive electrode active materials, and have excellent contact with the positive electrode active materials and connectivity between the solid electrolyte particles.

### Other Components

The solid electrolyte membrane may optionally further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may be applied without type limitations, and may include, for example, LiPF₆, LiBF₄, LiSbF₆, LiAsF₆, LiClO₄, LiAlO₂, LiAlCl₄, LiPO₂F₂, LICl, LiI, LiSCN, LIN(CN)₂, lithium bis(oxalato) borate (LiBOB), lithium difluorobis (oxalato) borate (LIDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETl), lithium trifluoromethane sulfonate, lithium tetrafluoroethane sulfonate, or a combination thereof.

For example, the lithium salt may be an imide-based lithium salt such as LiTFSI, LiFSI, LiBETl, or a combination thereof. The imide-based lithium salt may maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SOs—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### All-Solid-State Rechargeable Battery

In an embodiment, an all-solid-state rechargeable battery includes a positive electrode, a negative electrode, and the aforementioned solid electrolyte membrane positioned between the positive electrode and the negative electrode.

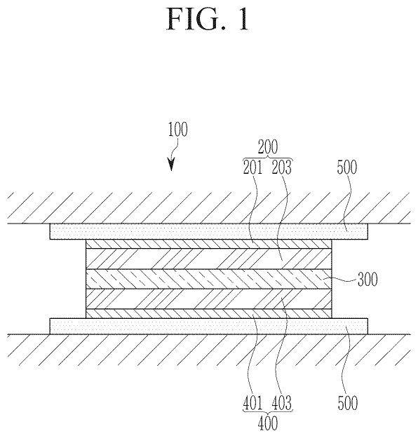

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material, may optionally include the aforementioned solid electrolyte.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may) be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

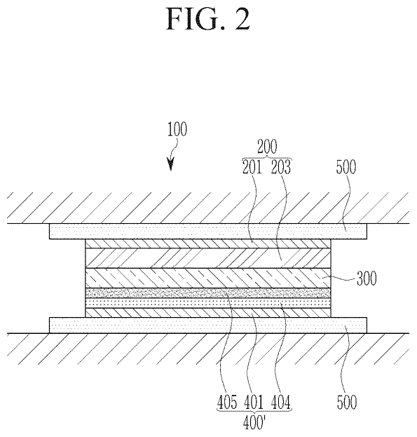

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned region or the first solid electrolyte layer may be referred to as a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material. At this time, the positive electrode active material layer may include the solid electrolyte described above.

### Positive Electrode Active Material

The positive electrode active material may be applied without limitation as long as it is generally used in all-solid-state rechargeable batteries. For example, the positive electrode active material may be a compound being capable of intercalating and deintercalating lithium, may include a lithium transition metal composite oxide, and may include a compound represented by one of the following chemical formulas.

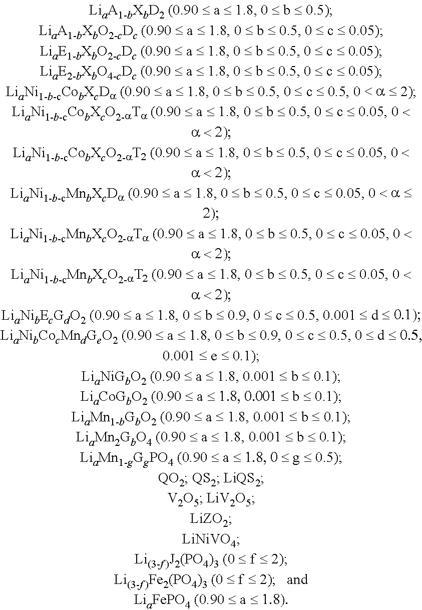

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NOM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

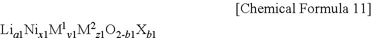

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

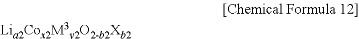

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

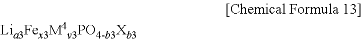

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

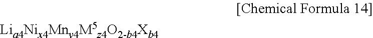

In Chemical Formula 14, 0.9≤a251.8, 0.8≤x4<1, 0<y4≤0.2, 0≤z40.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Manufacturing of Solid Electrolyte Membrane

A first solvent of isobutyryl isobutyrate (IBIB) and a second solvent of hexyl butyrate were mixed in a weight ratio of 80:20, and 2 wt % of an acrylic rubber binder and 98 wt % of a solid electrolyte (Li₃PS₅Cl, D50=3.5 μm) were added thereto and then, mixed to prepare a composition for a solid electrolyte membrane. The composition was coated on a PET release film with a blade coater and then, pre-dried at about 110° C. and vacuum-dried at about 80° C. to manufacture a solid electrolyte membrane with a thickness of about 100 μm to 150 μm.

2. Manufacturing of all-Solid-State Rechargeable Battery Cell

After preparing an Ag/C composite by mixing carbon black with a primary particle diameter (D50) of about 30 nm and silver (Ag) with an average particle diameter (D50) of about 60 nm in a weight ratio of 3:1, 0.25 g of the composite was added to 2 g of an NMP solution including 7 wt % of a polyvinylidene fluoride binder and then, mixed to prepare a negative electrode coating layer composition. The negative electrode coating layer composition was coated on a nickel foil current collector with a bar coater and then, vacuum-dried to prepare a precipitation-type negative electrode having a negative electrode coating layer on the current collector.

85 wt % of LiNi_{0.6}Co_{0.15}Mn_{0.05}O₂ coated with Li₂O—ZrO₂ as a positive electrode active material, 13.5 wt % of Li₃PS₅Cl as a solid electrolyte, 1.0 wt % of polyvinylidene fluoride as a binder, and 0.5 wt % of carbon nanotube as a conductive material were mixed to prepare a positive electrode composition. The prepared positive electrode composition was coated on a positive electrode current collector by using a bar coater and then, dried and compressed to manufacture a positive electrode.

The solid electrolyte membrane was stacked on the negative electrode, and then, the positive electrode was stacked thereon to manufacture a unit cell, and this unit cell was inserted into a laminate film and subjected to warm isostatic press (WIP) at 500 MPa for 30 minutes at 80° C. to manufacture an all-solid-state rechargeable battery cell.

### Comparative Example 1

An all-solid-state rechargeable battery cell was manufactured substantially in the same manner as in Example 1 except that the second solvent alone was used to manufacture the solid electrolyte membrane.

### Evaluation Example 1: Evaluation of Battery Cell Rate Characteristics

The all-solid-state rechargeable battery cells of Example 1 and Comparative Example 1 were charged at 0.1 C and discharged at 0.1 C as a first cycle, charged at 0.1 C and discharged at 0.33 C as a second cycle, and then, charged at 0.1 C and discharged at 1.0 C as a third cycle within a voltage range of 2.5 V to 4.25 V in a thermostat at 45° C. Then, the cells were measured with respect to charge capacity and discharge capacity at each cycle to calculate a ratio of the latter to the former as efficiency, and the results are shown in Table 1.

TABLE 1

| | | Charge | Discharge | |
|---|---|---|---|---|
| | | capacity | capacity | Efficiency |
| | | (mAh/g) | (mAh/g) | (%) |
| Example 1 | 0.1 C charge/0.1 C | 242.38 | 207.49 | 85.6 |
| | discharge | | | |
| | 0.1 C charge/0.33 C | 207.05 | 191.65 | 92.56 |
| | discharge | | | |
| | 0.1 C charge/1.0 C | 191.38 | 174.3 | 91.07 |
| | discharge | | | |
| Comparative | 0.1 C charge/0.1 C | 242.29 | 205.61 | 84.86 |
| Example 2 | discharge | | | |
| | 0.1 C charge/0.33 C | 206.1 | 190.83 | 92.59 |
| | discharge | | | |
| | 0.1 C charge/1.0 C | 190.66 | 167.18 | 87.68 |
| | discharge | | | |

Referring to Table 1, Example 1, in which the first and second solvents were appropriately mixed, compared with Comparative Example 2, to which the second solvent alone was applied, exhibited high discharge capacity at the first to third cycles and high charge and discharge efficiency at the third cycle, which confirmed that high rate capability was improved.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: all-solid-state battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. A solid electrolyte membrane, comprising
a sulfide-based solid electrolyte, a binder, a first solvent, and a second solvent,
wherein the first solvent is at least one selected from butyl butyrate, isobutyl isobutyrate, tetrahydrofuran, 2-methylbutyl butyrate, and ethyl acetate, and
the second solvent is at least one selected from hexyl butyrate, benzyl butyrate, benzyl isobutyrate, isopentyl butyrate, and octyl acetate.

2. The solid electrolyte membrane as claimed in claim 1, wherein
the first solvent has a boiling point of less than 190° C., and
the second solvent has a boiling point of greater than or equal to 190° C.

3. The solid electrolyte membrane as claimed in claim 1, wherein
the first solvent has a boiling point of 60° C. to 180° C., and
the second solvent has a boiling point of 200° C. to 280° C.

4. The solid electrolyte membrane as claimed in claim 1, wherein
the first solvent has a vapor pressure at 25° C. of greater than or equal to 1.00 mmHg, and
the second solvent has a vapor pressure at 25° C. of less than 1.00 mmHg.

5. The solid electrolyte membrane as claimed in claim 1, wherein
the first solvent has a vapor pressure at 25° C. of 1.00 mmHg to 20 mmHg, and
the second solvent has a vapor pressure at 25° C. of 0.001 mmHg to 0.90 mmHg.

6. The solid electrolyte membrane as claimed in claim 1, wherein
the first solvent is included in an amount of less than or equal to 0.1 wt % based on 100 wt % of the solid electrolyte membrane.

7. The solid electrolyte membrane as claimed in claim 1, wherein
second solvent is included in an amount of less than or equal to 0.1 wt % based on 100 wt % of the solid electrolyte membrane.

8. The solid electrolyte membrane as claimed in claim 1, wherein
a weight ratio of the first solvent to the second solvent is 10:90 to 95:5.

9. The solid electrolyte membrane as claimed in claim 1, wherein
a weight ratio of the first solvent to the second solvent is 70:30 to 90:10.

10. The solid electrolyte membrane as claimed in claim 1, wherein
the binder comprises a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

11. The solid electrolyte membrane as claimed in claim 1, wherein
the binder is included in an amount of 0.1 wt % to 3 wt % based on 100 wt % of the solid electrolyte membrane.

12. The solid electrolyte membrane as claimed in claim 1, wherein
the binder is uniformly distributed in the solid electrolyte membrane.

13. The solid electrolyte membrane as claimed in claim 1, wherein
the binder has a concentration gradient in a thickness direction of the solid electrolyte membrane.

14. The solid electrolyte membrane as claimed in claim 1, wherein
the sulfide-based solid electrolyte is in a form of particles and an average particle diameter of the particles is 0.1 μm to 5.0 μm.

15. The solid electrolyte membrane as claimed in claim 1, wherein
the sulfide-based solid electrolyte comprises argyrodite-type sulfide.

16. The solid electrolyte membrane as claimed in claim 15, wherein
the sulfide-based solid electrolyte particle comprises a compound represented by Chemical Formula 1: 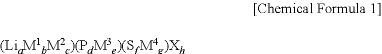
wherein in Chemical Formula 1,
4≤a≤8,
M¹ is Mg, Cu, Ag, or a combination thereof, 0≤b<0.5,
M² is Na, K, or a combination thereof, 0≤c<0.5,
M³ is Sₙ, Zn, Si, Sb, Ge, or a combination thereof, 0<d<4, 0≤e<<1,
M⁴ is O, SOₙ, or a combination thereof, 1.5≤n≤5, 3≤f≤12, 0≤g<2, and
X is F, Cl, Br, I, or a combination thereof, 0≤h≤2.

17. An all-solid-state rechargeable battery, comprising
a positive electrode,
a negative electrode, and
the solid electrolyte membrane as claimed in claim 1 between the positive electrode and the negative electrode.

18. The all-solid-state rechargeable battery as claimed in claim 17, wherein
a binder content on the surface of the solid electrolyte membrane in contact with the positive electrode is greater than a binder content on the surface of the solid electrolyte membrane in contact with the negative electrode.

19. The all-solid-state rechargeable battery as claimed in claim 18, wherein
the binder content increases from a surface in contact with the negative electrode to a surface in contact with the positive electrode within the solid electrolyte membrane.

20. The all-solid-state rechargeable battery as claimed in claim 17, wherein
the negative electrode comprises a current collector and a negative electrode coating layer disposed on the current collector and including a lithiophilic metal, a carbon material, or a combination thereof, and
a lithium metal layer formed by charging between the current collector and the negative electrode coating layer.
